(19) United States
(12) Patent Application Publication
(10) Pub. No.: US 2004/0241435 A1
(43) Pub. Date: Dec. 2, 2004

(54) Adhesive masking tape

(75) Inventors: Norbert Grittner, Hamburg (DE); Dieter Zielske, Barmstedt (DE); Petra Morbel, Hamburg (DE)

Correspondence Address: NORRIS, MCLAUGHLIN & MARCUS, PA, 875 THIRD STREET, 18TH FLOOR, NEW YORK, NY, 10022, US

(73) Assignee: Tesa AG, Hamburg (DE)

(21) Appl. No.: 10/822,058

(22) Filed: Apr. 8, 2004

(30) Foreign Application Priority Data
Apr. 11, 2003 (DE) 103 16 995.4

(51) Int. Cl. D21H 11/00; B32B 7/12

(52) U.S. Cl. 428/354; 428/537.5

(57) ABSTRACT

Adhesive masking tape having a preferably stretchable paper backing and an adhesive coating thereon, the paper backing produced as follows:

introducing plant fiber material into a pulper;

mixing the fiber material with water;

beating the fibers to produce a fiber dispersion;

feeding the fiber dispersion to form a paper web;

drying the paper web so that its solids content is between 15% and 35% by weight;

forming the paper web in a first press station;

drying the paper web again so that its solids content is between 50% and 60% by weight, and simultaneously stretching the paper web in a machine direction;

compacting the paper web in a second press station;

drying the paper web again so that its water content is between 15% and 4% by weight; and

transferring the paper web to a calender stack.

The present invention relates to an adhesive masking tape having a preferably stretchable paper backing with an adhesive coating on at least one side.

Self-adhesive masking tapes, referred to below as masking tape, are required to have certain key properties in order to meet the particular requirements imposed on them. These properties, without any claim to completeness, include the following: low thickness, high tensile strength (ultimate tensile strength), good stretchability (elongation of break), sufficient but not excessive bond strength, residueless redetachability after the stresses of the actual application, effective adhesion of coating materials to the reverse face, resistance to paint strikethrough, resistance to humidity, and graduated bond strength to its own reverse face. While certain of the properties can be attributed to the adhesive or to other functional layers of the masking tape, the stretchability and tensile strength are based essentially on the physical properties of the backing material used.

For adhesive masking tapes, consequently, it is preferred to use paper backings, especially those for which the nature of the pulp used, the freeness, and certain chemical assistants have endowed them with a defined tensile strength and where particular process steps such as creping or the Clupak process have endowed them with a defined stretchability.

These raw materials and process steps are exclusively the preserve of the paper maker's art and consequently are unavailable to the manufacturer of adhesive masking tapes, who as a general rule buys in the base paper as a basis for the adhesive masking tape.

The stretchability in particular, however, is an indispensable property of adhesive masking tapes. It is only stretchability which allows the tape to be applied by its full area and without creases to curves and to spherical surfaces, such as is necessary, for example, in connection with the refinishing of cars; in the case of manual application, the adhesive masking tape can be made to follow, perfectly, soft contours, and so leads to a clean paint edge with no underruns. The machine-direction stretch required for this purpose is in the region of 10% in the case of what is known as flat crepe and around 50% in the case of what is known as high crepe. Tensile strength and stretch are tailored to one another such that it is readily possible, during manual application, to remove part of the stretch on the outer curve of the adhesive masking tape without risk of cracking, and so to produce a curve.

The text below is intended to address the typical state-of-the-art operations involved in the production of stretchable paper backings in web form.

The backing material commonly used for adhesive masking tapes comprises mechanically creped papers, which are generally produced from 100% sodium kraft pulp. In the process known as wet creping, creping takes place generally in the paper machine with the aid of a creping doctor, on what is termed a creping cylinder either within or at the end of the press section or on one of the following cylinders of the dry section. By compressing the paper web on the leading edge of the creping doctor while the paper is still wet and labile, microcreasing is produced in the paper. This highly sensitive process step generally limits the maximum possible speed of the paper machine and shortens the length of the paper web by about 10 to 20%. In the course of the subsequent drying operation the creases are fixed substantially by the formation of hydrogen bonds, so that when the paper is mechanically stressed to a moderate extent in the longitudinal direction—such as occurs, for example, when an adhesive masking tape is unwound and a piece of appropriate length removed—the creases remain stable. The stability can be increased further by adding sizing agents, and so, be adapted to the particular end use. It is normally determined by a stress/strain diagram measurement. In accordance with this process it is possible to produce flat crepe having machine-direction elongations at break of up to 20%. The stretch in the cross-direction (or transverse direction) is generally not more than about 5%.

Another process for producing stretchable paper backings for adhesive masking tapes is that known as the CLUPAK process. Here, the fibers in the smooth paper are curled or compressed in the plane of the paper web by friction, by means of a destretching rubber cloth or rubber-coating rollers. The product is a stretchable paper whose curled fibers can be extended against under tensile stress. Microcreasing as described above cannot be discerned; the paper appears smooth and is therefore not to be regarded as crepe paper in the true sense. A characteristic of the papers produced by this process is a tensile strength which is already very high under low stretch and which increases further only slightly in the region of elongation at break. Consequently, in manual application, there is virtually no conformability of adhesive masking tape produced from such papers to spherical surfaces. Moreover, as a result of the process, the paper is highly compacted in the z direction and is therefore poor at absorbing dispersions in the course of the impregnation that is a typical part of adhesive masking tape manufacture. Normally, therefore, sized Clupak backings without impregnation are employed for adhesive masking tape. The stretch obtained is likewise up to 20% in the machine direction. Regarding this process and its product, reference may be made to DE 38 35 507 AI.

For achieving very high stretch levels of up to about 50% it is common to employ, in addition to the conventional wet creping process, which for that purpose is operated with particularly coarse creping doctors, the dry creping process. Here, a smooth paper is creped on a separate machine after remoistening with a binder solution (starch, CIVIC, PVAI), as described above, and then dried again. Both of these procedures produce what are known as high crepes, which in addition to the extreme stretchability are notable for a high thickness and a very rough surface.

The properties of these paper backings in web form not only critically determine the subsequent performance properties of the adhesive masking tape but are also characteristic of, and to some extent a limit on, its production.

DE 101 20 148 AI discloses an adhesive masking tape comprising a backing material with an adhesive coating applied to at least one side thereof. The backing material is composed of an uncreped web-form material, preferably of paper, whose elongation at break has been adjusted by mechanical embossing to a figure of between 2 and 70%.

In a first advantageous embodiment, the depth of roughness of the embossed backing material has been reduced by calendering without substantially impairing the stretch of the backing material.

DE 199 39 075 AI, furthermore, discloses a masking tape comprising a web-form backing based on paper or on nonwovens and a coating, applied to one of the two opposing sides of the backing, comprising a pressure-sensitive self-adhesive composition based on non-thermoplastic elastomers, obtained by a process for continuous solvent-free and mastication-free production in a continuously operating apparatus having a filling section and a compounding section, consisting of the following steps:

a) feeding the solid components of the self-adhesive composition, such as elastomers and resins, into the filling section of the apparatus, optionally feeding fillers, dyes and/or crosslinkers,

b) transferring solid components of the self-adhesive composition from the filling section to the compounding section,

c) adding the liquid components to the self-adhesive composition, such as plasticizers, crosslinkers and/or further tackifying resins, where appropriate in the melt state, to the compounding section,

d) preparing a homogeneous self-adhesive composition in the compounding section,

e) discharging the self-adhesive composition, and

f) coating the self-adhesive composition onto a web-form material using a multi-roll applicator unit, in particular a 2- to 5-roll applicator unit, very particularly a 4-roll applicator unit, so that the self-adhesive composition is shaped to the desired thickness as it passes through one or more roll nips, it being possible for the rolls of the applicator unit to be set individually to temperatures of from 20° C. to 150° C.

It is an object of the invention to provide an adhesive masking tape with a backing material which, independently of the paper making process, is endowed with a defined stretchability which in terms of extent and nature is set in such a way that it conforms to a particular degree to the requirements envisaged.

This object is achieved by means of the adhesive masking tape as specified hereinbelow.

The invention accordingly provides an adhesive masking tape having a preferably stretchable paper backing provided on at least one side with an adhesive coating, the paper backing being composed of a paper produced in an operation comprising the following steps:

introduction of plant fiber material into a pulper

mixing of the fiber material with water

beating of the fibers to produce a fiber dispersion, which is then transferred to a 'headbox

controlled feeding of the beaten fiber dispersion preferably onto a former wire and preferably continuous reduction of the water content to form a paper web, the reduction being preferably by gravity and/or vacuum

initial drying of the paper web, so that its solids content is between 15% and 45% by weight

forming of the paper web in a first press station

second drying of the paper web, so that its solids content is between 45% and 65% by weight, and simultaneous stretching of the paper web in machine direction

compaction of the paper web in a second press station

final drying of the paper web, so that its water content is between 15% and 4% by weight, preferably between 10% and 8% by weight

transfer of the paper web to a calender stack.

In a first advantageous embodiment the paper web produced from the fiber suspension is brought in the initial drying by mechanical dewatering to a dry matter content of from 25% to 45% by weight, preferably from 30% to 40% by weight, more preferably 35% by weight. In a second advantageous embodiment the formed paper web is brought in the second drying by thermal drying to a dry matter content of from 50% to 60% by weight.

The process for producing the paper backing used advantageously for an adhesive masking tape is further illustrated in detail below.

In this elucidation the process is embodied advantageously, and the parameters specified are also preferred parameters. There is no intention whatsoever thereby to restrict the invention in any way.

The bales of fiber raw material are introduced into the pulper together with a certain amount of water, and mixed. The fiber suspension is stirred and chemicals are added whose function is to raise the maximum strength of the fibers, to improve the homogenization of the fiber suspension with water, and to give the finished paper special properties.

The fiber raw material is preferably composed of plant fibers, which can be long-fibered cellulose, short-fibered cellulose or else other non-wood-derived plant fibers (cotton linters, hemp, flax, esparto, kenaf). The different materials can be processed on the same lines or, preferably, on different lines.

The rotor increasingly digests the material and mixes it intensely with the water and added chemicals while preserving the fiber length. The additives used can be starches, which bind the fibers together and increase their maximum strength, or carboxymethylcellulose (CIVIC), which stabilizes the suspension and so prevents coagulation,.or else synthetic resins, which improve the fiber bonds and ensure an elastic bond.

A fiber suspension made up of fibers, water and additives leaves the pulper with a dry matter content of approximately 15% by weight and is supplied to a subsequent multi-stage beating operation. The operation of beating in a preferred cascade of two or more units equipped with lava discs imparts particular properties to the fiber suspension. The fibers are worked on in particular by hydration and by squeezing and fibrillating beating, without being substantially shortened.

As a result of this treatment the fibers are modified in a way which allows a particularly large number of fiber linkage points, of large surface area, to form, which gives rise to uniform, intensive bonding of the fibers to one another. This structure is essential for the properties which the end product is to have.

The freeness of the fiber suspension can be determined on the basis of the objective parameter SR (Schopper Riegler). In accordance with the present invention the fiber suspension exiting the beating stage preferably has a freeness of between 25 and 65 DEG SR, more preferably between 30 DEG and 60 DEG SR, and very preferably between 40 and 60 DEG SR, depending on the grammage of the paper being made.

On leaving the last beating unit, the fiber suspension, which, as described, preferably has a freeness of between 30 and 60 DEG SR, can be transferred to a hollander, which operates at a density of approximately 20% and whose function is to bring about hydration, swelling and curling of the fibers. The fiber suspension is subsequently transferred to a storage chest and, from there, into the headbox, from which, with a solids content of approximately 0.5% to 1% by weight, it flows through the stock exit gap onto the underlying wire of the wet section.

In the first part of this machine wire the fiber suspension tends to give off water continuously, initially as a result of gravity and then by suction extraction with vacuum, until, at the exit from the wire, it has a dry matter content of around 18% by weight. The paper is subsequently conveyed on into the press section, where it runs between two press rolls and is thereby dried further to a dry matter content of around 35% by weight.

The paper then optionally enters the impregnating station, where it is treated with one or more liquid additives whose function is to improve the stretch properties of the paper or the processing properties. Impregnation is preferably carried out with a spray nozzle, although other systems are also possible; for example, the paper is passed through tanks containing impregnating fluid. In each case, the amount of impregnation can be controlled, which is of advantage, both for the costs and also in order to adjust the properties attained with precision and to keep them constant.

The paper thus treated is then supplied to a first forming step, which may be composed of one or more (identical or different) units.

Each unit can be composed alternatively of:

(1) a top roll having a structured profile and a smooth (soft) bottom roll having a smooth standard felt, with the paper web being located between the top roll and the felt.

(2) Two smooth rolls between which a structured felt is located such that it is able to form a paper web which runs between felt and top roll, the paper web being located between the top roll and the felt.

(3) A top roll having a structured profile, and a smooth bottom roll (without felt).

(4) Two smooth rolls and one smooth felt and one structured felt, with the paper web being located between the top roll and the top felt.

The use of two or more identical or different forming units makes it possible to produce structures in the paper of virtually any desired design.

The paper thus preformed is dried to a constant residual moisture content of from 15% to 60% by weight, preferably 50% by weight, by passing it over heated rolls or through a drying tunnel. Upstream of these there may be a further drying or heating station, preferably in the form of an infra-red station.

During transfer of the paper from the press station to the compacting station, the roll speeds are adapted in such a way that the paper, in accordance with its maximum strength, is stretched in the machine direction. This leads to a contraction in the transverse direction, and hence to a reserve of stretch in the transverse direction.

In the compacting station the paper is compacted in machine direction and in transverse direction and hence the stretch in machine and transverse directions is produced. For this purpose the paper is passed through at least one roll pair of different type and different surface quality, and with different speeds.

The bottom roll of each roll pair is a rubber roll which runs at a defined speed. The top roll is made of metal and has a multiplicity of surface ribs, for example circulating ribs, and runs at a higher speed. The applied pressure and the geometry of the metal roll surface—which interacts with the rubber surface of the bottom roll—produce a structuring in the paper, for example a groove formation in the machine direction. At the same time, as a result principally of the different roll speeds, a breaking effect is exerted by the rubber roll, thereby producing a compaction in the machine direction.

In another advantageous embodiment of the invention the stretchability is generated by the still-wet paper web being simultaneously compressed in machine direction and transverse direction, and profiled, on the paper machine in a roll nip between a hard roll, which is grooved in the direction of the periphery and which runs approximately at web speed at the periphery, and a roll which is softer than the first roll and which runs more slowly at the periphery than the first roll.

Following compaction, the paper is dried to a residual moisture content of from 4% to 15% by weight, preferably between 8% and 10% by weight. It should be noted that, until the paper exits this drying station, the roll speed is adapted so that the paper is not subject to any tension and the longitudinally compacted paper loses none of its stretchability in machine direction.

Downstream of the drying station the paper is optionally calendered, thereby improving, for example, the printability of the paper produced. This is operated with a nip load of from 10 to 100 kg/cm, preferably from 40 to 60 kg/cm.

Finally the paper runs into a downstream winding station. Before this station it is possible to operate a further impregnating and drying station in order to improve the printing properties, if that is needed.

The part-process of producing the paper is disclosed in EP 0 824 619 AI. That disclosure content is expressly incorporated by reference to become part of the present disclosure content.

The paper produced in this way is known to the person skilled in the art as “mould paper”.

The production process can be modified depending on the requirement imposed on the backing paper.

For instance,

stock sizing during paper making may ensure better moisture resistance, higher pick resistance and higher bonding strength,

calendering may ensure a reduction in profile depth, so that less adhesive need be applied for a given bond strength,

a reduction in or, if desired, complete abandonment of groove formation and hence of the increased transverse-direction stretch as compared with normal flat crepe, may ensure a retention of the longitudinal stretch and strength in the case of further-reduced thickness.

With further preference the backing web is subjected to permanent three-dimensional deformation, advantageously by means of a thermoforming operation.

In one advantageous embodiment, between papermaking and the application of the adhesive coating, the backing material is calendered and/or further impregnated with polymer dispersions.

It is also possible, if desired, for a release varnish and/or primer to be applied at least to one side of the backing material.

The backing material is preferably composed of a paper which in machine direction has a breaking elongation of at least 15%, but preferably at least 20%, and in the transverse direction a breaking elongation of at least 5%, but preferably at least 10%, but very preferably at least 15%.

The breaking elongation is the increase in length of a sample strip at the moment of tearing 15 in the course of a tensile test, expressed as a percentage of the original clamped-in length.

In one advantageous embodiment of the invention the basis weight of the backing material is from 35 to 250 g/m², preferably from 50 to 200 g/m², very preferably from 70 to 150 g/m².

The use of the stretchable and in particular compacted paper backing, in accordance with the invention, as backing material for pressure-sensitive adhesive tapes has the following advantages over the use of the known high-crepe paper backings:

As a result of high longitudinal stretch, the paper, which is inexpensive and of a light weight comparable to that of flat crepe, can also be used for conventional high crepe applications normally requiring more expensive high crepe paper backings.

In contrast to high crepe, the backing material is substantially thinner for a same strength, leading to a flatter paint edge when used as adhesive masking tape.

As a result of the longitudinal structure, the resulting paint edges are substantially cleaner than in the case of the transverse structure of conventional high crepe or flat crepe papers stretched in application, which frequently produce underruns of paint into the folds of the crepe.

Even in the unstretched state of the backing web, the resultant paint edge is cleaner, owing to the longitudinal structure, as compared with high crepe which is not at full stretch.

As a result of the single-stage manufacturing operation, the backing material is less expensive to produce.

The paper backing material is more finger-friendly, owing to its longitudinal structure as compared with the coarse transverse structure of the high crepe papers.

The higher tensile forces at low stretch allow more effectively controlled utilization of the stretch reserves.

Longitudinal grooves in the backing result in lower unwind forces and gentler unwind characteristics.

The use of the stretchable and in particular compacted paper backing material for pressure sensitive adhesive tapes, in accordance with the invention, has the following advantages over the use of the known flat crepe paper backings:

The longitudinal stretch of the backing of the invention can be made higher than in the case of conventional flat crepe; therefore, narrow curves and more crease-free bonding on spherical surfaces are possible.

Even in unimpregnated form the backing paper is impervious to coating materials, as a result of greater beating and compaction and hence low absorbency.

By virtue of a beating process which produces greater fibrillation and less cutting, and as a result of the compaction, the paper backing is substantially stronger than a flat crepe of equal weight.

Replacing the strength-reducing creping operation by a strength-enhancing compaction operation in the stretch-producing roll nip achieves a comparatively high strength of the stretchable paper for the same pulp use.

Longitudinal grooves in the backing result in lower unwind forces and gentle unwind even without coating.

Should a release be used, partial coating of the longitudinal ribs can be performed with a suitable coating process (for example direct gravure or offset gravure coating), thereby allowing a saving to be made in terms of release coating.

At the same time, as a result of less release, the anchoring of the paint is better than in the case of flat crepe.

The longitudinal grooves result in only partial efficacy of the adhesive; accordingly, demasking from sensitive substrates can be accomplished particularly easily and uniformly.

The costs in paper finishing as a result of reduction or absence of release and/or impregnation, owing to greater strength of the base paper and owing to the longitudinal structure, are lower.

The unusually high transverse stretch allows crease-free overbonding of profiles such as cables, trim strips and the like in the longitudinal direction.

The unusually high transverse stretch is able to compensate high loads in the transverse direction, such as arise, for example, as a result of shrinkage of paper masks under hot conditions.

The structural differences between the two sides are greater than in the case of flat crepe; accordingly, coating of the convexly or concavely grooved side, alternatively, can be utilized in order to achieve particularly low unwind forces (release coating on concave side) or bond strength (pressure-sensitive adhesive on concave side).

The longitudinal structure prevents the paints flowing or creeping transversely over the adhesive tape onto the unpainted substrate.

As a result of the thermoformability it is possible to produce adhesive tapes having a three-dimensional structure: for example, cover caps which are self-adhesive at the edge.

1. A process for preparing a stretchable paper backing, said process comprising the following steps:
(a) introducing plant fiber material into a pulper;
(b) mixing the fiber material with water;
(c) beating the fiber material to produce a fiber dispersion;
(d) feeding the fiber dispersion in a controlled manner to form a paper web;
(e) drying the paper web a first time, so that its solids content is between 15% and 35% by weight;
(f) forming the paper web in a first press station;
(g) drying the paper web a second time, so that its solids content is between 50% and 60% by weight, and simultaneously stretching the paper web in a machine direction;
(h) compacting the paper web in a second press station;
(i) drying the paper web a third time, so that its water content is between 15% and 4% by weight; and
(j) transferring the paper web to a calender stack.

2. The process according to claim 1, wherein in step (c) the fiber material is beaten onto a former wire and/or a water content of the fiber material is continuously reduced.

3. The process according to claim 1, wherein in step (i) the paper web is dried so that its water content is between 10% and 8% by weight.

4. The process according to claim 1, wherein the fiber suspension during beating is worked on with squeezing and fibrillation but with less cutting.

5. The process according to claim 4, wherein the fiber suspension during beating is worked on with squeezing and fibrillation but with less cutting through the use of a cascade of two or more beater units fitted with lava disks.

6. The process according to claim 1, wherein a freeness of the fiber dispersion (determined by the Schopper-Riegler method) is from 25 to 65 Deg SR.

7. The process according to claim 6, wherein a freeness of the fiber dispersion (determined by the Schopper-Riegler method) is from 30 to 60 Deg SR.

8. The process according to claim 1, wherein the fiber dispersion is hydrated and curled in a hollander.

9. The process according to claim 1, wherein the forming of the paper web takes places on the first press station, which comprises a roll pair or of a sequence of two or more roll pairs selected from the following group:
a) a top roll having a structured profile and a smooth bottom roll having a smooth standard felt, with the paper web being located between the top roll and the felt;
b) two smooth rolls between which a structured felt is located such that there can be formed a paper web which runs between felt and top roll, the paper web being located between the top roll and the felt;
c) a top roll having a structured profile, and a smooth bottom roll (without felt); or
d) two smooth rolls and one smooth felt and one structured felt, with the paper web being located between the top roll and the top felt.

10. The process according to claim 1, wherein the paper web is compacted by a second press station, which comprises at least one roll pair with rolls of different types, at least in the longitudinal direction.

11. The process according to claim 10, wherein the paper web is compacted by a second press station, which comprises at least one roll pair with rolls of different types, both in the longitudinal direction and in the transverse direction at the same time, the roll pair comprising a first roll and a second roll, the first roll being harder than the second roll, the first roll having a predetermined surface quality and the second roll being smooth and running slower at a periphery than the first roll.

12. The process according to claim 11, wherein the first roll is a steel roll and the second roll is a rubber roll.

13. The process according to claim 12,wherein the steel roll on its surface has a peripherally grooved structure.

14. The process according to claim 1, comprising during the second drying stretching the paper web in a machine direction by means of a precisely controlled preacceleration of consecutive web-guiding rolls.

15. The process according to claim 14, wherein the second drying is thermal.

16. The process according to claim 14, wherein said stretching is set at a level such that an ultimate tensile strength of the paper web is substantially attained during this step.

17. The process according to claim 1, wherein the backing comprises a paper which in a machine direction has a breaking elongation of at least 15% and in a transverse direction a breaking elongation of at least 5%.

18. The process according to claim 17, wherein the backing comprises a paper which in a machine direction has a breaking elongation of at least 20% and in a transverse direction a breaking elongation of at least 10%.

19. The process according to claim 18, wherein the backing comprises a paper which in a transverse direction has a breaking elongation of at least 15%.

20. The process according to claim 19, wherein a basis weight of the backing is from 35 to 250 g/m².

21. The process according to claim 20, wherein the basis weight of the backing is from 50 to 200 g/m².

22. The process according to claim 21, wherein the basis weight of the backing is from 70 to 150 g/m².

23. The process according to claim 1, wherein the fiber material comprises non-wood-derived plant fibers.

24. The process according to claim 23, wherein the non-wood-derived plant fibers are selected from the group consisting of cotton linters, hemp, flax, esparto and kenaf.

25. An adhesive masking tape comprising:
(a) a stretchable paper backing produced according to claim 1; and
(b) an adhesive coated on one or both sides of said backing.

26. The adhesive masking tape according to claim 25, wherein the adhesive is a solvent-based or solvent-free self-adhesive composition.

27. The adhesive masking tape according to claim 26, wherein the adhesive is based on natural rubber, polyacrylates, styrene block copolymers, ethylene-vinyl acetate, polyurethane, poly-alpha-olefins, polyisobutylene, or styrene-butadiene rubber.

28. A method of masking a surface comprising applying an adhesive masking tape according to claim 25 to said surface to mask said surface.
